(19) United States
(12) Patent Application Publication
(10) Pub. No.: US 2005/0019944 A1
(43) Pub. Date: Jan. 27, 2005

(54) Colorable microspheres for DNA and protein microarray

(75) Inventors: Tiecheng A. Qiao, Webster, NY (US); Jeffrey W. Leon, Rochester, NY (US); Kurt M. Schroeder, Spencerport, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/625,424

(22) Filed: Jul. 23, 2003

(51) Int. Cl. G01N 21/00

(52) U.S. Cl. 436/169; 422/58

(57) ABSTRACT

A microarray comprising: a support, on which is disposed a layer of microspheres bearing biological probes; wherein said microspheres comprise at least one material with a latent color that can be developed and used to identify said microsphere. A method of identifying biological analytes using the microarray is also disclosed.

### CROSS REFERENCE TO RELATED APPLICATIONS

This application relates to commonly assigned copending application Ser. No. ______ (85507), entitled PHOTOCHROMIC DYES FOR MICROSPHERE BASED SENSOR, application Ser. No. ______ (85677), entitled COLORABLE POLYMERIC PARTICLES WITH BIOLOGICAL PROBES, and application Ser. No. ______ (85486), entitled LARGE POLYMER BEADS CONTAINING COUPLERS AND METHOD OF PREPARATION filed simultaneously herewith. The copending applications are incorporated by reference herein for all that they contain.

### FIELD OF THE INVENTION

The present invention concerns biological microarray technology in general. In particular, it concerns an array of microspheres immobilized on a substrate and a method of exposing the surface of the microspheres to analytes contained in test samples. The microspheres contain latent colorants that identify the microspheres when the color is switched on. The microspheres also bear capture agents (also called probes) on their surfaces.

### BACKGROUND OF THE INVENTION

Current technologies have used various approaches to fabricate microarrays. For example, U.S. Pat. Nos. 5,143,854, 5,412,087, and 5,489,678 demonstrate the use of a photolithographic process for making peptide and DNA microarrays. The patent teaches the use of photolabile protecting groups to prepare peptide and DNA microarrays through successive cycles of deprotecting a defined spot on a 1 cm×1 cm chip by photolithography, then flooding the entire surface with an activated amino acid or DNA base. Repetition of this process allows construction of a peptide or DNA microarray with thousands of arbitrarily different peptides or oligonucleotide sequences at different spots on the array. This method is expensive. An ink jet approach is being used by others (e.g., U.S. Pat. Nos. 6,079,283; 6,083,762; and 6,094,966) to fabricate spatially addressable arrays, but this technique also suffers from high manufacturing cost in addition to the relatively large spot size of 40 to 100 μm.

An alternative approach to the spatially addressable method is the concept of using fluorescent dye-incorporated polymeric microspheres to produce biological multiplexed arrays. U.S. Pat. No. 5,981,180 discloses a method of using color coded microspheres in conjunction with flow cytometry to perform multiplexed biological assay. Microspheres conjugated with DNA or monoclonal antibody probes on their surfaces were dyed internally with various ratios of two distinct fluorescence dyes. Hundreds of “spectrally addressed” microspheres were allowed to react with a biological sample and the “liquid array” was analyzed by passing a single microsphere through a flow cytometry cell to decode sample information. U.S. Pat. No. 6,023,540 discloses the use of fiber-optic bundles with pre-etched microwells at distal ends to assemble dye loaded microspheres. The surface of each spectrally addressed microsphere was attached with a unique bioactive agent and thousands of microspheres carrying different bioactive probes combined to form “microspheres array” on pre-etched microwells of fiber optical bundles. More recently, a novel optically encoded microsphere approach was accomplished by using different sized zinc sulfide-capped cadmium selenide nanocrystals incorporated into microspheres (Nature Biotech. 19, 631-635, (2001)). Given the narrow band width demonstrated by these nanocrystals, this approach significantly expands the spectral barcoding capacity in microspheres.

Even though the “spectrally addressed microsphere” approach does provide an advantage in terms of its simplicity over the old fashioned “spatially addressable” approach in microarray making, there was still a need in the art to make the manufacture of biological microarrays less difficult and less expensive.

U.S. Ser. No. 09/942,241 provides a microarray that is less costly and easier to prepare than those previously disclosed because the support need not be modified; nevertheless the microspheres remain immobilized on the substrate. U.S. Ser. No. 09/942,241 provides a microarray comprising: a substrate coated with a composition comprising microspheres dispersed in a fluid containing a gelling agent or a precursor to a gelling agent, wherein the microspheres are immobilized at random positions on the substrate. The substrate is free of receptors designed to physically or chemically interact with the microspheres. That invention utilizes a unique coating composition and technology to prepare a microarray on a substrate that need not be pre-etched with microwells or premarked in any way with sites to attract the microspheres, as disclosed in the art.

U.S. Ser. No. 09/942,241 teaches various coating methods and exemplifies machine coating, whereby a support is coated with a fluid coating composition comprising microspheres dispersed in gelatin. Immediately after coating, the support is passed through a chill set chamber in the coating machine where the gelatin undergoes rapid gelation and the microspheres are immobilized.

While that invention provides a huge manufacturing advantage over then existing technologies, it presents some limitations as well. Like many current approaches of making microsphere-based microarray, it involves color barcoding of individual microsphere with a uniquely detectable optical signal from the colorant incorporated in the microspheres, and the color intensity and hue are associated with a unique biological probe covalently attached to the surface of the microsphere. However, such approach suffers two problems: (1) the colorant itself emits fluorescence that interferes with the fluorescence signal resulting from the biological interaction; (2) when the adsorption wavelength of the barcoding dye is complementary to the biological interaction fluorescence emission, the fluorescence signal intensity is significantly suppressed. Problem 1 severely limits the color barcoding diversity of the microspheres, and problem 2 dramatically reduces the dynamic range and low detection limit of the microarray system.

### SUMMARY OF THE INVENTION

The present invention overcomes the problem outlined above by disclosing a microsphere based microarray system that consists of a microarray comprising:
a support, on which is disposed
a layer of microspheres bearing biological probes;
   wherein said microspheres comprise at least one material with a latent color that can be developed and used to identify said microsphere.

The invention also discloses methods of utilizing such microarray, one method comprising the steps of:
providing an array of microspheres comprising latent colorants and biological probes;
making contact between said microspheres and said biological analytes, the analytes being labeled with optical emission tags;
allowing interaction between the biological analytes and the probes;
washing the array to remove unbound analytes;
recording signals from the optical emission tags, said signals generated from the binding of probe and analyte, and recording said signals as Image A;
developing the latent compounds in the microspheres into detectable optical signatures;
recording the optical signatures as Image B; and
comparing Images A and B to determine the identities and concentrations of the biological targets.

An alternative method discloses the steps of:
providing microspheres that contain latent colorants and bear biological probes on their surfaces;
making contact between the microspheres and analytes, wherein the analytes are labeled with optical emission tags;
allowing interaction between the biological probes and the analytes;
washing microspheres to remove unbound analytes;
immobilizing said microspheres on a 2-dimensional surface of a support to form a microarray;
measuring signals from the optical emission tags, said signals generated from the interaction of probe and analyte, and recording the signals as Image A;
developing the latent colorants in the microspheres into detectable optical signatures and recording the signatures as Image B;
comparing Images A and B to determine the identity and concentration of the analytes.

### ADVANTAGEOUS EFFECTS OF THE INVENTION

The present invention includes several advantages, not all of which are incorporated in a single embodiment. In one advantage, the microsphere of the present invention may overcome one particular problem associated with “spectrally addressed microspheres”, wherein the colored compounds typically used in the microspheres are often fluorescent, and hence will provide excessive “background noise” when fluorimetric determinations are performed on the microarray. This problem can be overcome through the use of latent colorants, which are colorless and relatively non-emissive until “switched” to a colored state by a chemical reaction, a physical trigger, or some kind of environmental stimulus. In another advantage, the use of latent colorant significantly expands the “spectral bar coding” capacity of the microsphere which allows a large number of diversity of microspheres to be generated. Thus, a single array can afford to measure increased number of target analytes in a single experiment. In another advantage of the present invention, the colorless coding offers no detectable background fluorescence from microspheres, therefore the limit of detection is dramatically improved. As such, another advantage is that the microarray prepared according to the present invention also provide a broad dynamic range for measurement of target analytes.

### BRIEF DESCRIPTION OF THE DRAWINGS

FIG. 1A schematically shows a microarray support 1 on which microspheres incorporated with latent colorants 2 are immobilized. A biological probe 3 is attached to the surface of each microsphere.

FIG. 1B schematically shows a microarray containing microspheres with latent colorants incorporated 2; some microspheres 2 are bound with emission tag-labeled analytes 4 on their surfaces 2.

FIG. 1C schematically shows the microarray with the latent colorants inside each microsphere 2 switched into detectable optical signatures by either physical or chemical means.

### DETAILED DESCRIPTION OF THE INVENTION

The invention discloses a microsphere-, also referred to as “beads”-, based microarray on a support. Each microsphere in the microarray has a distinct optical signature that can distinguish that microsphere from other microspheres that have different optical signatures—that is, the signature is unique. As such, the invention provides a microarray comprising a support with a layer of microspheres immobilized in a 2-dimensional plane, in a randomly or orderly distributed pattern.

As used herein, the term “microarray” or “array” means a plurality of randomly or orderly distributed microspheres in a 2-dimensional plane on a support. The microspheres are incorporated with one or more than one compound, wherein that compound is a latent colorant from which a color can be developed by chemical or physical means. Bioactive probes can be, and usually are, attached to the surface of the microspheres. As used herein, bioactive probes include, but are not limited to, polynucleotide, polypeptide, polysaccharides, and small synthetic molecules that are capable of interacting specifically with certain biological targets. Preferred bioactive probes are nucleic acids and proteins. A microarray typically contains microspheres of more than one colorant type, and with more than one type of bioactive probe. The size and shape of an array can vary depending on composition and intended use. In addition, an array may contain multiple sub-arrays in various formats.

In the present invention, the distribution or pattern of the microspheres on the support can be ordered or entirely random. The microspheres are immobilized in a 2-dimesional plane on the surface of a support. The possible supports include, but not limited to, glass, metals, polymers, and semiconductors. The support can be transparent or opaque, flexible or rigid. In some cases, the support can be a porous membrane e.g. nitrocellulose and polyvinylidene difluoride. The microspheres are immobilized onto the surface of the support by physical or chemical interactions between the support and the microspheres. To improve robustness and reproducibility, it is more desirable to immobilize the microspheres onto a modified surface using certain chemical functional agents, that is, the surface is chemically treated or modified to allow attachment of the microspheres. As will be appreciated by those skillful in the art, the surface can also be modified to provide physical forces, e.g. electrostatic, magnetic, compressive, adhesive, etc., that allow the attachment of the microspheres to such modified surfaces. Generally the support surface is planar, however it can also be a modified surface that contains regular or irregular 3-dimensional configurations, for example micro wells, or cavities, can be used to immobilize the microspheres on a surface by embedding the microspheres into the wells. The microspheres can also be immobilized on a 2-dimensional plane by allowing the microsphere to flow through a confined space, e.g. a tube, a chamber, that allows the microspheres to assemble into a 2-dimensional array.

In a preferred embodiment, the microspheres are immobilized on the surface using a coating method that involves “sol-to-gel” transition process. As used herein, the term “sol-to-gel transition” or “gelation” means a process by which fluid solutions or suspensions of particles form continuous three-dimensional networks that exhibit no steady state flow. This can occur in polymers by polymerization in the presence of polyfunctional monomers, by covalent cross-linking of a dissolved polymer that possesses reactive side chains and by secondary bonding, for example, hydrogen bonding, between polymer molecules in solution. Polymers such as gelatin exhibit thermal gelation that is of the latter type. The process of gelation or setting is characterized by a discontinuous rise in viscosity. (See, P. I. Rose, “The Theory of the Photographic Process”, 4^{th} Edition, T. H. James ed. pages 51 to 67).

As used herein, the term “gelling agent” means a substance that can undergo gelation as described above. Examples include materials such as gelatin, water-soluble cellulose ethers or poly(n-isopropylacrylamide) that undergo thermal gelation or substances such as poly(vinyl alcohol) that may be chemically cross-linked by a borate compound. Other gelling agents may be polymers that may be cross-linked by radiation such as ultraviolet radiation. Examples of gelling agents include acacia, alginic acid, bentonite, carbomer, carboxymethylcellulose sodium, cetostearyl alcohol, colloidal silicon dioxide, ethylcellulose, gelatin, guar gum, hydroxyethylcellulose, hydroxypropyl cellulose, hydroxypropyl methylcellulose, magnesium aluminum silicate, maltodextrin, methylcellulose, polyvinyl alcohol, povidone, propylene glycol alginate, sodium alginate, sodium starch glycolate, starch, tragacanth and xanthum gum. (For further discussion on gelling agents, see, accompanying reference Secundum Artem, Vol. 4, No. 5, Lloyd V. Allen). A preferred gelling agent is alkali pretreated gelatin.

Coating methods are broadly described by Edward Cohen and Edgar B. Gutoff in Chapter 1 of “Modem Coating And Drying Technology”, (Interfacial Engineering Series; v.1), (1992), VCH Publishers Inc., New York, N.Y. For a single layer format, suitable coating methods may include dip coating, rod coating, knife coating, blade coating, air knife coating, gravure coating, forward and reverse roll coating, and slot and extrusion coating.

Drying methods also vary, sometimes with surprisingly varying results. For example, when the fluid gelatin/microsphere composition is rapidly dried by chill setting, gelation occurs before the gelatin has had time to flow from the raised surfaces of the microspheres, causing a layer of gelatin to be formed that blocks direct contact between the microsphere surface and any agent to be deposited thereon. When the fluid composition is allowed to dry more slowly at ambient temperatures, the gelatin flows from the microsphere surface, leaving the microsphere substantially free of gelatin. By “substantially free” it is meant that the surface of the microsphere is sufficiently free of gelatin to interact with a probe or agent to attach thereto.

Microspheres or beads may comprise, but are not limited to, polymer, glass, or ceramic. Preferably the microspheres are made from polymeric materials. Suitable methods for preparing the polymeric microspheres are emulsion polymerization as described in “Emulsion Polymerization” by I. Piirma, Academic Press, New York (1982) or by limited coalescence as described by T. H. Whitesides and D. S. Ross in J. Colloid Interface Science, vol. 169, pages 48-59, (1985). The particular polymer employed to make the particles or microspheres is a water immiscible synthetic polymer that may be colored. The preferred polymer is any amorphous water immiscible polymer. Examples of polymer types that are useful are polystyrene, poly(methyl methacrylate) or poly(butyl acrylate). Copolymers such as a copolymer of styrene and butyl acrylate may also be used. Polystyrene polymers are conveniently used.

The formed microsphere is incorporated with insoluble latent colorants that are organic or inorganic and are not dissolved during subsequent treatment. Suitable compounds may be oil-soluble in nature. It is preferred that the compounds be non-fluorescent when incorporated in the microspheres. Although microspheres or particles having a substantially curvilinear shape are preferred because of ease of preparation, particles of other shape such as ellipsoidal or cubic particles may also be employed.

The microspheres are desirably formed to have a mean diameter in the range of 1 to 50 microns; more preferably in the range of 3 to 30 microns and most preferably in the range of 5 to 20 microns. It is preferred that the concentration of microspheres in the coating is in the range of 100 to a million per cm², more preferably 1000 to 200,000 per cm² and most preferably 10,000 to 100,000 per cm².

On the surface of a microsphere, a bioactive probe is attached. As used herein, bioactive probes include, but not limited to, polynucleotide, polypeptide, polysaccharides, and small synthetic molecules that are capable of interacting specifically with certain biological targets. Preferred bioactive probes are nucleic acids and proteins.

Nucleic acids are polynucleotide biological molecules that carry genetic information. There are two basic kinds of nucleic acids and they are deoxyribonucleic acid (DNA) and ribonucleic acid (RNA). A DNA molecule consists of four nucleotide bases, A, T, G, and C, which are connected in linear manner covalently; and a RNA molecule consists of four bases, A, U, G, and C, which are connected in linear manner covalently. The interaction among four bases follows the “Watson-Crick” base pairing rule of A to T (U) and G to C mediated by hydrogen bonds. When two single strand DNA molecules having a perfect “Watson-Crick” base paring match, they are referred as a complementary strand. The interaction between two complementary strands is termed hybridization. As such, a single-stranded DNA or RNA can be used as a bioactive probe to interact with its complementary strand. Sometimes, the complementary strand may contain one or more base-pairing mismatches as well.

Some commonly used nucleic acid bioactive probes which can used in the invention include, but not limited to, DNA and DNA fragments, RNA and RNA fragment, synthetic oligonucleotides, and peptide nucleic acids. In another embodiment of the invention, the nucleic acid bioactive probes can be any protein scaffold or synthetic molecular moiety capable of recognizing a specific DNA sequence. A nucleic acid bioactive probe can be terminally modified to contain one or more than one chemical functional groups that can be used to attached to another molecule or a surface. Some commonly used terminal modifications include, but not limited to, amino, thiol, carboxyl, biotin, and digoxigenin.

A protein molecule consists of 20 amino acids that are connected in linear manner covalently. Some proteins can be further modified at selected amino acids through post-translational processes that include phosphorylation and glycosylation. A protein molecule can be used as a bioactive probe. Protein bioactive probes can interact with proteins in high affinity and high specificity. Typically it is desirable to have an affinity binding constant between a protein bioactive probe and target protein greater than 10⁶ M⁻¹. There are several classes of molecules that can be used as protein bioactive probes on a protein microarray.

Antibodies are a class of naturally occurring protein molecules that are capable of binding targets with high affinity and specificity. The properties and protocols of using antibody can be found in “Using Antibodies; A Laboratory Manual”, (Cold Spring Harbor Laboratory Press, by Ed Harlow and David Lane, Cold Spring Harbor, N.Y. 1999).

Antigens can also be used as protein bioactive probes if antibodies are intended targets for detection. Protein scaffolds such as whole protein/enzyme or their fragments can be used as protein bioactive probes as well. Examples include phosphotases, kinases, proteases, oxidases, hydrolyases, cytokines, chemokines, or synthetic peptides. Nucleic acid ligands can be used as protein bioactive probes after in vitro selection and enrichment for their binding affinity and specificity to certain targets. The principle of such selection process can be found in Science, Vol. 249, 505-510, 1990 and Nature, Vol. 346, 818-822, 1990. U.S. Pat. No. 5,110,833 discloses an alternative class of synthetic molecules that can mimic antibody binding affinity and specificity and can be readily prepared by the so called Molecular Imprinting Polymer (MIP). This technology has been reviewed in Chem. Rev. Vol. 100, 2495-2504, 2000.

The attachment of nucleic acid bioactive probes and protein bioactive probes to the surface of chemically functionalized microspheres can be performed according to the published procedures in the art (Bangs Laboratories, Inc, Technote #205). Some commonly used chemical functional groups on the surface of the microspheres include, but not limited to, carboxyl, amino, hydroxyl, hydrazide, amide, chloromethyl, epoxy, aldehyde, etc.

In a preferred embodiment, one microsphere is only associated with one type of bioactive probe. It is also preferred that the bioactive probes are synthesized first, and then covalently attached to the microspheres. However, as will be appreciated by those in the art, the bioactive probes can also be synthesized in situ on the microspheres. By either means, linkers of various lengths can be used to connect bioactive probes with the microspheres to provide flexibility for optimized interactions between the bioactive probes and the target molecules.

According to the present invention, a microsphere further comprises one or more than one latent colorant as optical signature. As used herein, the term “latent colorant” means a molecule with adsorption and emission characteristics that can be modulated by chemical or physical means. It is preferred that a latent colorant be colorless and not fluoresce. In a preferred embodiment, the optical signature is generated by using one latent colorant or a mixture of more than one latent colorant. As used herein, the term “optical signature” means an adsorption or emission signal that can be detected and/or measured through optical methods. Such signals include, but are not limited to, adsorbence, fluorescence, and chemiluminescence.

According to the present invention, a microsphere further comprises one or more than one latent colorant in the microsphere as optical signature. As used herein, the term “latent colorant” means a molecule of whose adsorption and emission characteristics can be modulated using a chemical or a physical means. It is preferred that a latent colorant is colorless and does not have fluorescence. In a preferred embodiment, the optical signature is generated by using one latent colorant or a mixture of more than one latent colorant. As used herein, the term “optical signature” means an adsorption or emission signal that can be measured through optical methods. Such signals include, but not limited to, adsorbence, fluorescence, and chemiluminescence. Either the concentration of a single latent colorant or the ratio of the latent colorants (when more than one latent colorants are used) can be varied to generate a library of unique optical signature encoded microspheres, as such each microsphere in the library is associated with a unique bioactive probe attached to the microsphere. For example, when a signature is derived from a single latent colorant, the amount of latent colorant incorporated into the microsphere will designate a unique sub-set of microsphere with a particular type of biological probe on the microsphere surface. For signatures derived from more than one latent colorants, the ratio of the compounds, e.g. 1:2 for two latent colorants, or 1:2:1 for three latent colorants, will be used to designate a unique sub-set of microsphere with a particular type of biological probes on the microsphere surface. A latent colorant can be organic, inorganic, and polymeric. A latent colorant is associated with a microsphere by either covalent binding or non-covalent interaction, either on the surface of the microsphere or incorporated inside the microsphere. In a preferred embodiment, a latent colorant is incorporated into a microsphere using a loading process. In another preferred embodiment, a colorable compound is incorporate into a microsphere during the synthetic process of the microsphere.

In order to determine the amount and the ratio of the colorable compound in a microsphere, the colorable compound needs to be converted into detectable optical signals. Generally speaking, the conversion can be achieved through either chemical means or physical means. Some chemical means of changing a latent colorant into measurable optical signature include, but are not limited to, condensation reaction, acid-base reaction, redox reaction, abstraction reaction, addition reaction, elimination reaction, chain propagated reaction, complexation reaction, molecular coupling reaction, rearrangement, and combination of two or more of the foregoing. Some physical means of changing a latent colorant into measurable optical signature can be achieved through the action of electromagnetic or corpuscular radiation, such as a photo initiated process, a thermo initiated process, a X-ray initiated process, an electron beam initiated process, an electrical initiated process, a pressure initiated process, a magnetic initiated process, and combination of two or more of the foregoing. Preferred physical methods include a photo initiated process, a thermo initiated process, an ionizing radiation initiated process, an electron beam initiated process, an electrical initiated process, a pressure initiated process, a magnetic initiated process, an ultrasound initiated and combination of two or more of the foregoing. As will be appreciated by those in the art, chemical means can be combined with a physical means as well. Generally latent colorants incorporated into microspheres can be switched into measurable optical signature by using a developer solution if a chemical means is employed. As used herein, the term “developer” means an aqueous or an organic solution, that upon making contact with the microsphere incorporated with the latent colorants, can switch the latent colorants into measurable optical signatures.

In a preferred embodiment, pH change can be used as a chemical means to switch latent colorants into detectable optical signatures, for example, as described in U.S. Pat. Nos. 5,053,309, leuco dye precursors with structures shown below can be incorporated into microspheres as latent colorants and these leuco dye precursor incorporated microspheres, upon making contact with an acidic developer, can be converted into measurable optical signatures. As used herein, the R, R1, R2, R3, R4, and R5 shown in all chemical structures are generic substitutions that consist of, but are not necessarily limited to, a single bond, a hydrogen atom, a carbon atom, an oxygen atom, a sulfur atom, a carbonyl group 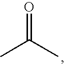
a carboxylic ester group 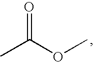
a carboxylic amide group 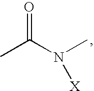
a sulfonyl group 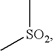
a sulfonamide group 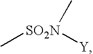
an ethyleneoxy group, a polyethyleneoxy group, or an amino group 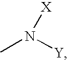
where substituents X, Y, and Z are each independently a hydrogen atom, or an alkyl group of 1-10 carbon atoms; and linear or branched, saturated or unsaturated alkyl group of 1 to 10 carbon atoms (such as methyl, ethyl, n-propyl, isopropyl, t-butyl, hexyl, decyl, benzyl, methoxymethyl, hydroxyethyl, iso-butyl, and n-butyl); a substituted or unsubstituted aryl group of 6 to 14 carbon atoms (such as phenyl, naphthyl, anthryl, tolyl, xylyl, 3-methoxyphenyl, 4-chlorophenyl, 4-carbomethoxyphenyl and 4-cyanophenyl); and a substituted or unsubstituted cycloalkyl group of 5 to 14 carbon atoms such as cyclopentyl, cyclohexyl, and cyclooctyl); a substituted or unsubstituted, saturated or unsaturated heterocyclic group (such as pyridyl, primidyl, morpholino, and furanyl); a cyano group.

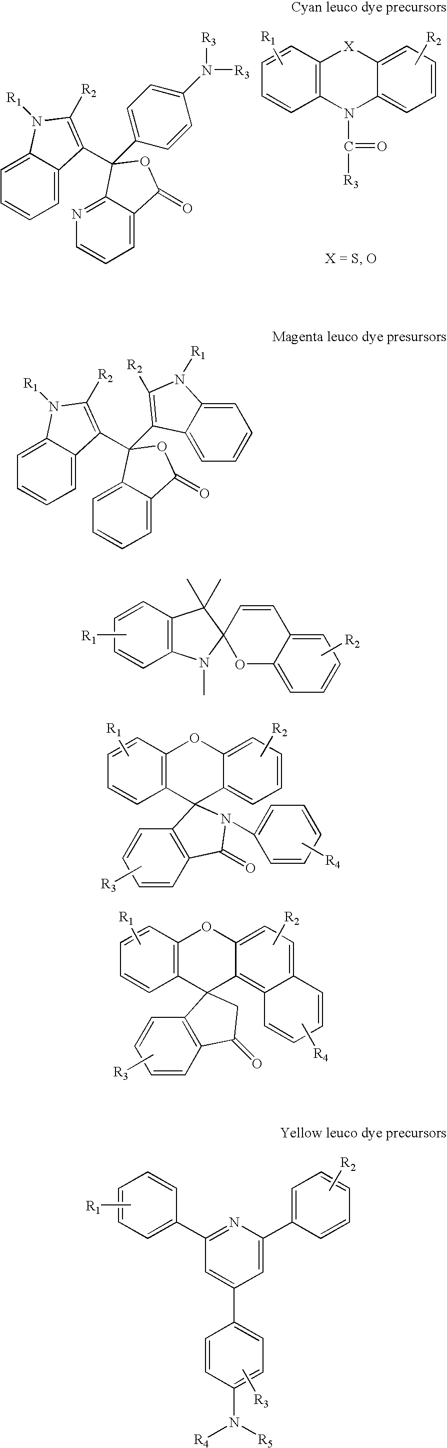

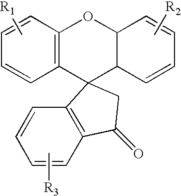

In another preferred embodiment, redox reaction is used as a chemical means to switch latent colorants into detectable optical signatures, for example, photographic couplers with structures shown below can be incorporated into microsphere as latent colorants. These couplers, as described by Friedrich, L. E. and Kapecki, J. A. in Chapter 2 of Handbook of Imaging Materials, 2^{nd} Ed, edited by Diamond and Weiss, Marcel Dekker, Inc., New York (200 1), upon redox coupling with quinonediimine or quinonediimine derivatives, can form cyan, magenta, and yellow colors as measurable optical signatures. Preferred redox coupling agents include, but are not limited to, N,N-diethyl p-phenylenediamine sulfate (KODAK Color Developing Agent CD-2), 4-amino-3-methyl-N-(2-methane sulfonamidoethyl)aniline sulfate, 4-(N-ethyl-N-β-hydroxyethylamino)-2-methylaniline sulfate (KODAK Color Developing Agent CD-4), p-hydroxyethylethylaminoaniline sulfate, 4-(N-ethyl-N-2-methanesulfonylaminoethyl)-2-methylphenylenediamine sesquisulfate (KODAK Color Developing Agent CD-3), 4-(N-ethyl-N-2-methanesulfonylaminoethyl)-2-methylphenylenediamine sesquisulfate, and others readily apparent to one skilled in the art. Another class of useful redox coupling agents that can react with cyan, magenta and yellow coupler to form dyes of various colors are diazonium salts. These coupling reactions have been described in “The Theory of the Photographic Process”, 4^{th} Edition, T. H. James ed. Chapters 11 and 12.

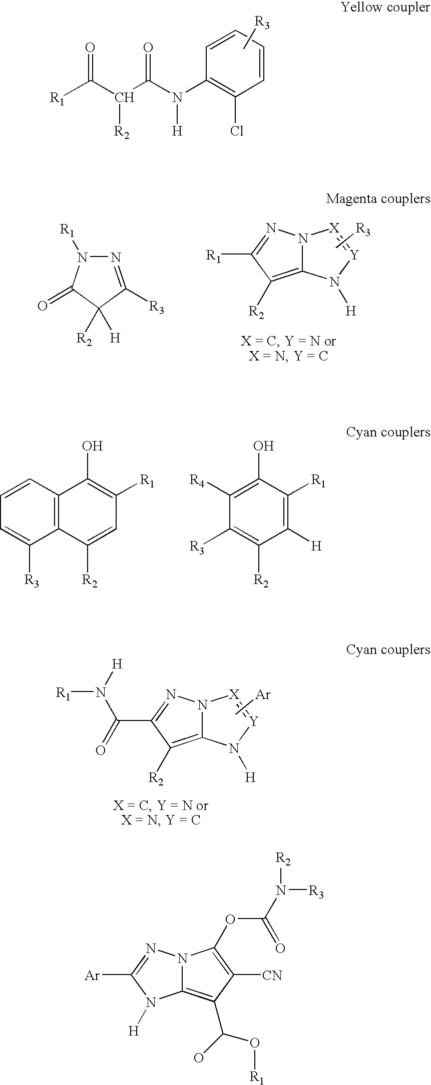

In another preferred embodiment, complexation reaction is used as a chemical means to switch latent colorants into detectable optical signatures, for example, as described in U.S. Pat. Nos. 4,555,478, 4,568,633, and 4,701,420, ferrous ligands complex with structure of 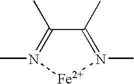
can be form to generate various colors. As such these ligands, when incorporated into microsphere as latent colorants, upon contacting with a developer containing ferrous ion, can form distinct colors as measurable optical signatures. Several examples of such ligands include, but not limited to, the following structures:

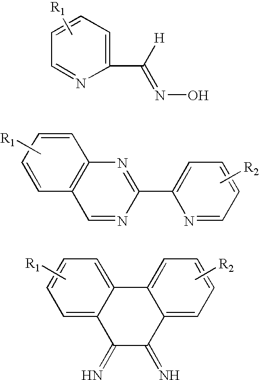

In another preferred embodiment, photo initiation process is used as a physical means to switch latent colorants into detectable optical signatures. Several examples included, but not necessarily limited to, photo radical initiated dye formation as described in U.S. Pat. Nos. 3,394,391, 3,394,392, 3,394,395, 3,410,687, 3413,121, and reviewed by Wainer, E. in SPSE Symposium No. III, Unconventional Photographic Systems, Washington D.C. (1971), pp39-41, and photo initiated photochromic dye formation as reviewed by Jacobson, R. E. in Photopolymerization and Photoimaging Science and Technology, Allen, N. S. edited, Elsevier Applied Science, London, (1989) and by Ichimura, K. in Photochromism, Durr and Bouas-Laurent edited, Elsevier, Amsterdam, (1990). The reaction schemes that can result in the formation of distinguishable colors as measurable optical signatures are shown below. As will be appreciated by those in the art, these compounds can be easily incorporated into the microspheres as latent colorants and upon photo initiation, can be converted into measurable optical signatures.

Commonly owned Docket No. 85507, filed on even date herewith, discloses and claims the use of photochromic dyes. That disclosure is incorporated herein in its entirety.

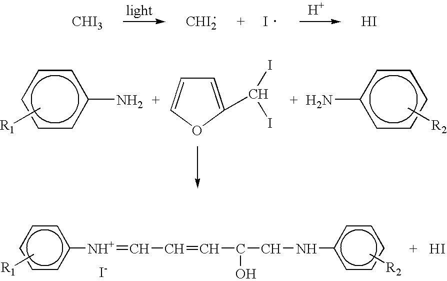

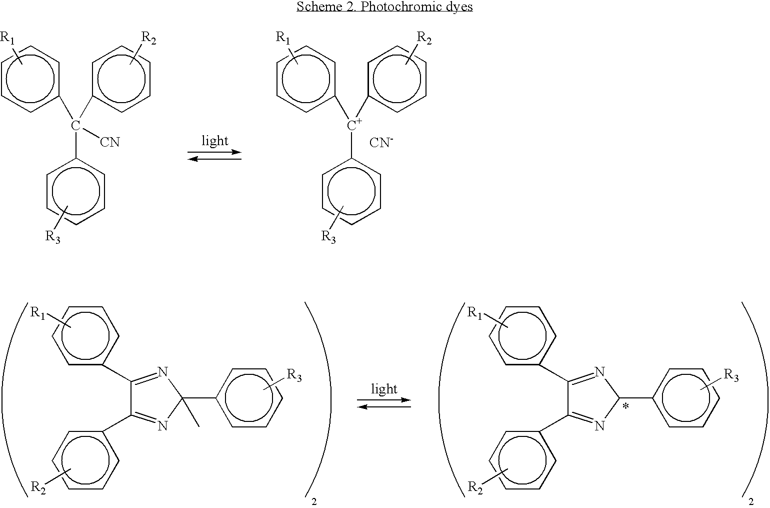

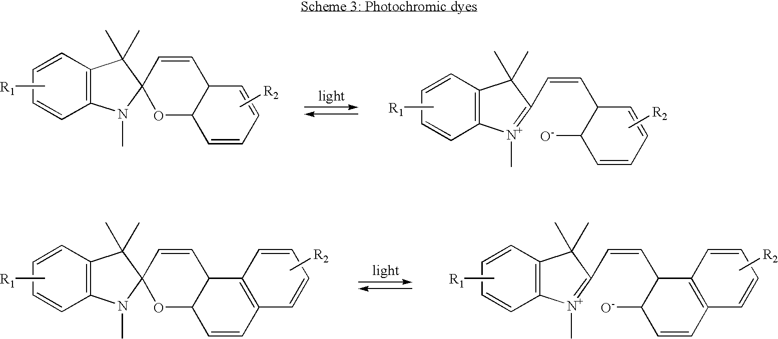

In another preferred embodiment, thermo initiation processes, as described by Day, J. H. in Chem. Rev., 63, 65, (1963), 68, 649, (1968), by Mustafa, A. in Chem. Rev., 43, 509, (1948), and by Bergman, E. et al in J. Am. Chem. Soc. 81, 5605, (1959), can be used as a physical means to switch latent colorants into detectable optical signatures. Several examples that can result in the formation of color as measurable optical signatures upon thermo initiation include, but are not limited to, compounds shown in Scheme 4. As will be appreciated by those in the art, these compounds can be easily incorporated into the microspheres as latent colorants and upon thermo initiation, can be converted into measurable optical signatures.

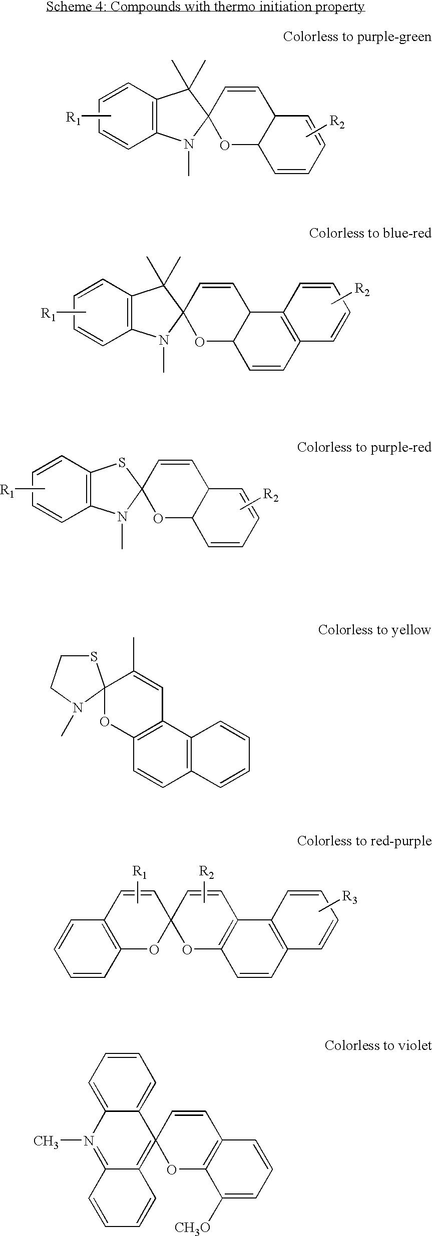

As will be appreciated in the art, the various processes of forming colors using latent colorants disclosed above can be used individually or in combination to generate a library of color coded microspheres.

Once the latent colorants are incorporated into microspheres, the identity of each type of microsphere can be distinguished by switching latent colorants into measurable optical signature through physical or chemical means at any time. Each type of microsphere can have attached to its surface a “bioactive probe” as described above. Therefore, each microsphere with a unique composition of latent colorants can correspond to a specific bioactive probe. These microspheres may be mixed in equal amounts, and the microarray fabricated by immobilizing the mixed microspheres onto a 2-dimensional surface in a single or multilayer format as described above.

The invention further discloses a process of using such microarray. In a typical microarray analysis process, a biological sample solution containing a mixture of analytes is uniformly labeled with “emission tags”, wherein “analyte” or “analyte molecule” refers to a molecule, typically a macromolecule, such as a polynucleotide, polypeptide, and polysaccharides, whose presence, amount, and/or identity are to be determined. Some commonly used emission tags include, but not limited to, fluorescers, chemiluminescers, radioactive molecules, enzymes, enzyme substrates, and other spectroscopically detectable labels. Alternatively, a molecule that can emit fluorescence, chemiluminescence, or spectroscopiclly detectable signals upon binding with other molecules can also be used as emission tags.

Once an emission tag has been selected, the methods of labeling nucleic acids have been described in Molecular Cloning, A Laboratory Manual, by Sambrook and Russell, 3^{rd} Ed, Cold Spring Harbor Laboratory Press, New York (2001); in Bio/Technology 6:816-821, (1988) by Kambara, H. et al, and in Nuc. Acids Res. 13:2399-2412, (1985) by Smith, L. et al; the methods of labeling polypeptides have been described in chapter 5 of Sequencing of Proteins and Peptides, by Allen, G., Elsevier, New York (1989) and in Chemistry of the Amino Acids, by Greenstein and Winitz, Wiley and Sons, New York (1961); and the methods of labeling polysaccharides have been described in Carbohydrate Analysis: A practical Approach, by Chaplin and Kennedy, IRL Press, Oxford (1986). After the target analytes in a biological sample are labeled with emission tags, they can be applied to a microsphere based microarray.

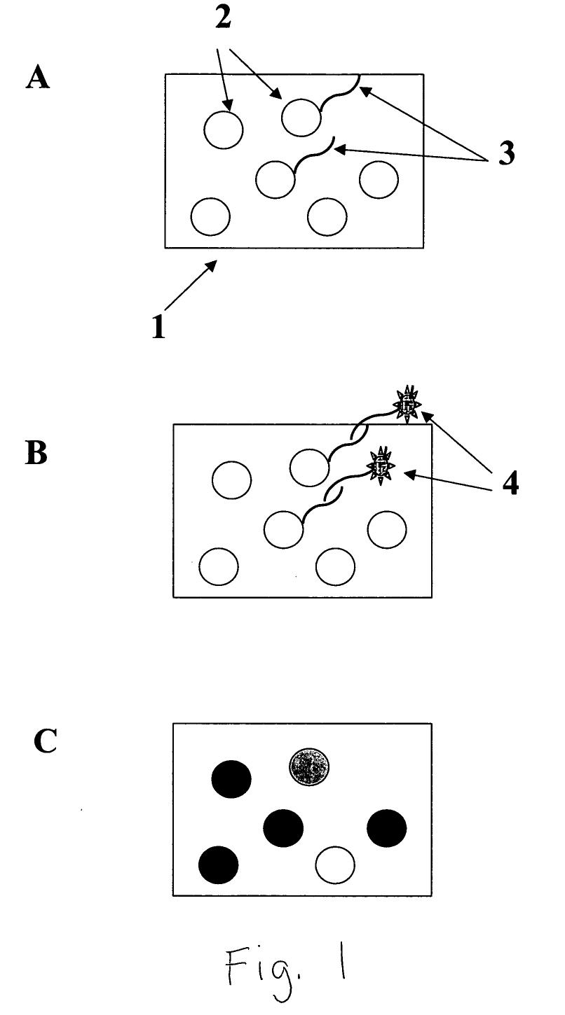

In a traditional microsphere based microarray, the signals from “color addressable” polymeric microspheres are measured first, followed by the measurement of emission tag signals resulting from the interaction between labeled analytes and the biological probes on the surface of the microspheres. In the instant invention, the measurement of emission tag signals resulting from the interaction between labeled analytes and the biological probes on the surface of the microspheres is performed first, followed by the switching of the latent colorants incorporated in the microspheres into detectable optical signals through physical or chemical means. The inventive process has been schematically shown in FIG. 1.

In FIG. 1A, a microarray containing microspheres is prepared. The microarray consists of a microarray support 1 on which microspheres incorporated with latent colorants 2 are immobilized. The biological probe 3 is attached to the surface of the microspheres.

In FIG. 1B, a solution containing emission tag-labeled analytes 4 is applied to the microarray. This step requires good physical contact between the microarray and the sample bearing the analyte(s); such contact is possible by either placing a layer of sample solution on the microarray or dipping the microarray into the sample solution. Unbound analytes (for example analytes not specifically complementary to the probes) will be removed in this step by multiple washing of the microarray in buffer solution. The emission tags 4 signals which result from the interactions of the analytes with the probes on the surface of the microspheres 2, are measured by an imaging system. The recorded image is designated IMAGE 1 and stored in a computer.

In FIG. 1C, the latent colorants inside the microspheres 2 are switched into color by chemical or physical means. A bright field illumination condition is used to capture the colored microspheres image to obtain the optical signature/barcode information of the immobilized microspheres in the microarray; the image is designated IMAGE 2 and stored in a computer.

Finally, both IMAGE 1 and IMAGE 2 can be analyzed and decoded by using an image processing algorithm to identify and quantify the unknown analytes by comparing IMAGE 1 with IMAGE 2.

An alternative process of using this invention involves some slight modifications of the process described above. In a preferred embodiment, a suspension containing a library of microspheres, each microsphere carrying a unique bioactive probe, was allowed to interact with target analytes labeled with emission tags. The unbound analytes will be removed by discarding supernatant after spinning down the microspsheres through centrifugation and filtration. Upon completion of interacting microspheres with emission tag labeled analytes, the resulting microspheres are immobilized on a 2-dimensional surface of a support. At this point, the alternate process continues as described above, as follows.

The emission tags 4 signals which result from the interactions of the analytes with the probes on the surface of the microspheres 2, are measured by an imaging system. The recorded image is designated IMAGE 1 and stored in a computer.

In FIG. 1C, the latent colorants inside the microspheres 2 are switched into color by chemical or physical means. A bright field illumination condition is used to capture the colored microspheres image to obtain the optical signature/barcode information of the immobilized microspheres in the microarray; the image is designated IMAGE 2 and stored in a computer.

Finally, both IMAGE 1 and IMAGE 2 can be analyzed and decoded by using an image processing algorithm to identify and quantify the unknown analytes by comparing IMAGE 1 with IMAGE 2. Both the emission tag signals and the optical signal from the microspheres may be measured and analyzed by a charge coupled device after image enlargement through an optical system. The requirements and specification of such imaging system have been described in details in U.S. patent application Ser. No. 10/036,828.

The invention can be better appreciated by reference to the following specific examples.

### EXAMPLE 1

This examples illustrates two methods of loading photographic couplers as latent colorants into polystyrene microspheres.

Loading method 1: For a typical preparation, a microsphere sample was prepared using a single coupler, or a fixed ratio of more than one couplers, and different ratios of coupler, coupler solvent, and auxiliary coupler solvent. The cyan coupler CYAN 1 was loaded using the sonication method as follows: 0.08 g CYAN 1 was dissolved in 0.8 g cyclohexanone and 0.08 g tricresolphosphate with stirring. This oil phase was then added to an aqueous phase of 0.48 g FAC-0064 (surfactant) and 6.52 g water with stirring at room temperature. The sample was sonicated for 1 min, producing a milky white dispersion, and then let stir. An equivalent amount, 8.0 g, of 4% 1 0-micron polystyrene microspheres was added to the sonicated sample. After mixing, the samples were poured into diafiltration bags and washed for six hours. After the diafiltration, the microspheres loaded with coupler are ready for further uses.

Loading method 2: For a typical preparation, a microsphere sample was prepared using a single coupler, or a fixed ratio of more than one couplers, and different ratios of coupler, coupler solvent, and auxiliary coupler solvent. The magenta coupler MAG 1 and the yellow coupler YEL 1 were loaded using this method as follows: 1.0 g of MAGI was dissolved in 10 g of cyclohexanone and 1.0 g tricresolphosphate solvent with stirring. After the coupler was dissolved, the oil phase was then added to an aqueous phase of 6.0 g FAC-0064 and 81.5 g water using a premixer. The milky dispersion produced was passed once through a microfluidizer at 7000 psi. Four grams each of the microfluidized sample and 4% 10-micron polystyrene microspheres were mixed and washed in diafiltration bags for six hours. After the diafiltration, the microspheres loaded with coupler are ready for further uses.

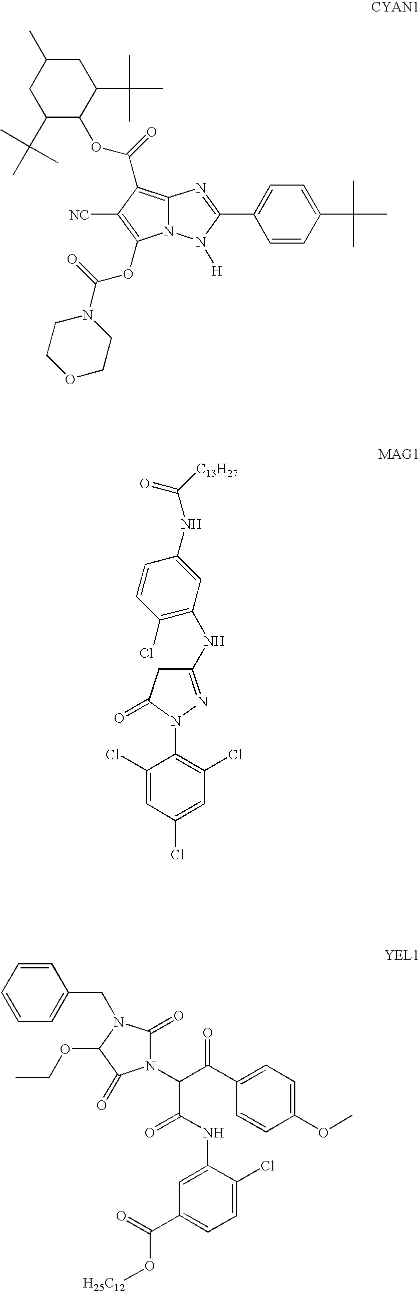

All three colored couplers and the mixture of the three can be loaded into the polystyrene microspheres using the methods outlined above.

### EXAMPLE 2

These examples illustrate a method of loading photographic couplers as latent colorants into polystyrene microspheres using in situ polymerization process.

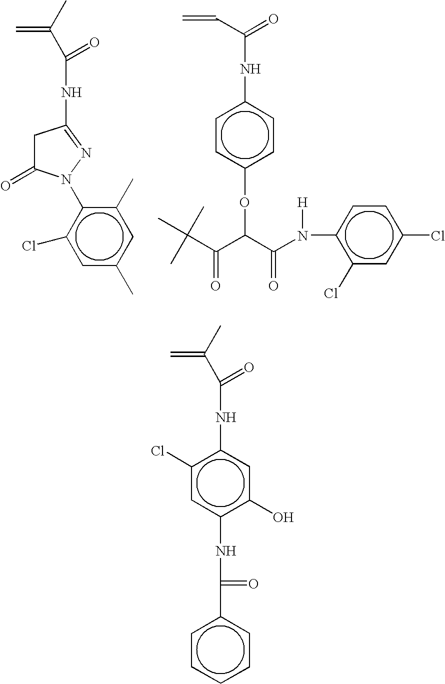

TABLE 1

| Monomer-coupler 1 | Monomer-coupler 2 | Monomer-coupler 3 |
|---|---|---|
| (cyan) | (yellow) | (magenta) |

TABLE 2
Reagents used in the preparation of beads containing monomer-bound
couplers and characterization data.

| Bead # | 1 (cyan) | 2 (yellow) | 3 (magenta) |
|---|---|---|---|
| Monomer- | 0.85 | — | — |
| coupler 1 (g) | | | |
| Monomer- | — | 0.85 | — |
| coupler 2 (g) | | | |
| Monomer- | — | — | 0.85 |
| coupler 3 (g) | | | |
| Styrene (ml) | 36.6 | 36.6 | 36.6 |
| AIBN (g) | 0.38 | 0.38 | 0.38 |
| Ethanol (ml) | 87.5 | 87.5 | 87.5 |
| Methyl | 125.0 | 125.0 | 125.0 |
| cellosolve | | | |
| (ml) | | | |
| Polyacrylic | 3.75 | 3.75 | 3.75 |
| acid (g) | | | |
| Mean | 4.26 | 4.92 | 7.54 |
| particle | | | |
| diameter | | | |
| (μm) | | | |

Beads 1-3, containing cyan, magenta, and yellow couplers (Couplers 1-3) respectively, were all synthesized by the same procedure using the reagents and quantities listed in Table 2. Polyacrylic acid (3.75 g, Mw=450K) was dissolved in 67.5 ml absolute ethanol in a 500 ml 3-neck round bottom flask equipped with a nitrogen inlet, mechanical stirrer, and reflux condenser. 125 ml methyl cellosolve was added and the resulting solution was placed in a thermostatted water bath at 65° C. and bubble degassed for 10 minutes with nitrogen. The monomer-coupler was separately dissolved in a solution of the remaining ethanol (20.0 ml) and 36.6 ml styrene with gentle heating. After the monomer solution returned to room temperature, 0.38 g AIBN was added and the solution was stirred until completely dissolved and was similarly bubble degassed with nitrogen for 10 minutes. The monomer/initiator solution was added all at once to the flask. Within 15 minutes the reaction turned slightly cloudy. The reaction was allowed to stir at 250 RPM for 2 hours at 65° C. then overnight (approx. 16 hours) at 75° C. The product beads were purified by centrifugation followed be decantation of the supernatants and redispersion in methanol. This was repeated 3-4 times with the final redispersion step using water. The beads were stored as dispersions of 5-20% w/w in water.

### EXAMPLE 3

This example illustrates the attachment of pre-synthesized single strand oligonucleotide probe to the surface of coupler incorporated microspheres.

One hundred microliters of coupler incorporated microspheres (4% w/v) was rinsed three times in acetate buffer (0.01 M, pH5.0), and combined with one hundred microliters of 20 mM 2-(4-Dimethylcarbomoyl-pyridino)-ethane-1-sulfonate and ten percent of polyethyleneimine. The mixture was agitated at room temperature for one hour and rinsed three times with sodium boric buffer (0.05 M, pH8.3). The beads were re-suspended in sodium boric buffer.

An oligonucleotide DNA probe with 5′-amino-C6 modification was dissolved in one hundred microliters of sodium boric buffer to a final concentration of 40 nmol. A 20 microliters of cyanuric chloride in acetonitril was added to the DNA probe solution and the total volume was brought up to 250 microliter using sodium boric buffer. The solution was agitated at room temperature for one hour and then dialyzed against one liter of boric buffer at room temperature for three hours.

A 100 microliters of the dialyzed DNA solution was mixed with 200 microliters of beads suspension. The mixture was agitated at room temperature for one hour and rinsed three times with sodium phosphate buffer (0.01 M, pH7.0).

### EXAMPLE 4

This example illustrates the attachment of an antibody bioactive probe to the surface of coupler incorporated microspheres.

One hundred microliters of coupler incorporated microspheres (4% w/v) was rinsed three times in acetate buffer (0.01 M, pH5.0), and combined with one milliliter of 50 mM 2-(4-Dimethylcarbomoyl-pyridino)-ethane-1-sulfonate. The mixture was agitated at room temperature for one hour and rinsed three times with sodium acetate buffer (0.01 M, pH5.0). A goat-anti-mouse IgG of 1 mg was added to the microspheres along with one milliliter of sodium acetate buffer (0.01 M, pH5.0). The mixture was agitated at room temperature for one hour and rinsed three times with 0.01 M phosphate saline buffer pH 7.0. Such antibody modified microspheres are ready for further uses.

### EXAMPLE 5

This example illustrates the hybridization and detection of target nucleic acid sequences to the gelatin coated microsphere on a glass support.

An oligonucleotide DNA with 5′-Cy3 labeling, which has complementary sequence to the DNA probe attached to the surface of the microspheres as shown in EXAMPLE3, was dissolved in a hybridization solution containing 0.9 M NaCl, 0.06 M NaH₂PO₄, 0.006 M EDTA, and 0.1% SDS, pH 7.6 (6×SSPE-SDS) to a final concentration of 1M. A microscope glass slide was first coated with a layer of gelatin by spreading 50 microliters of 2.5% gelatin solution on the surface of the glass slide. After the gelatin, a microsphere suspension of 1% prepared according to Example 3 containing 0.5% of bis(vinylsulfonyl) methane were applied onto the gelatin pre-coated glass slide and were allowed to dry to immobilize microspheres on 2-dimensional surface of the glass slide. The bead coated glass slide was hybridized in the hybridization solution starting at room temperature for 1 hour. Following hybridization, the slide was washed in 0.5×SSPE-SDS for 15 minutes three times.

The hybridization completed slide was imaged with an Olympus BH-2 fluorescence microscope (Diagnostic Instruments, Inc. SPOT camera, CCD resolution of 1315×1033 pixels) to detect the fluorescence signals resulted from DNA hybridization on the surface of the microspheres.

### EXAMPLE 6

This example illustrates the detection of protein target molecule to the gelatin coated microsphere on a glass support.

Mouse IgG of 0.001 mg/mL labeled with Cy3 or Cy5 was prepared in 0.05 M phosphate buffer, and combined with a suspension of 1% goat-anti-mouse modified microspheres as described in EXAMPLE 4 to a total volume of one milliliter. The mixture was incubated at room temperature with gentle agitation for one hour. The beads were spun down after the incubation and rinsed three times in phosphate buffer pH7.0 0.1% tween 20. A microscope glass slide was first coated with a layer of gelatin by spreading 50 microliters of 2.5% gelatin solution on the surface of the glass slide. After the gelatin, a microsphere suspension of 1% containing 0.5% of bis(vinylsulfonyl) methane were applied onto the gelatin pre-coated glass slide and were allowed to dry to immobilize microspheres on 2-dimensional surface of the glass slide.

After drying, the glass slide was imaged with an Olympus BH-2 fluorescence microscope (Diagnostic Instruments, Inc. SPOT camera, CCD resolution of 1315×1033 pixels) to detect the fluorescence signals resulted from protein interactions on the surface of the microspheres.

### EXAMPLE 7

This example illustrates the development of coupler incorporated microspheres into color on a gelatin coated glass support.

For each sample development, 1 mL of microspheres was washed twice with pH 10.10, 0.1 M sodium carbonate buffer and then the microspheres were re-suspended to 0.6 mL in either the pure carbonate buffer or the carbonate buffer containing a small percentage of Benzyl alcohol (3.5%). Thereupon, 0.2 mL of a developer solution with 3.5 g/L para-phenylenediamine in degassed water was added, followed by 0.2 mL of an oxidizing solution of 20 g/L of K₂S₂O₈ in water. The microsphere mixture was allowed to react for 30 minutes at room temperature with agitation. The microsphere solution was then spun down for 1.5 minutes and rinsed twice with water.

A microscope glass slide was first coated with a layer of gelatin by spreading 50 microliters of 2.5% gelatin solution on the surface of the glass slide. After the gelatin, a microsphere suspension of 1% containing 0.5% of bis(vinylsulfonyl) methane were applied onto the gelatin pre-coated glass slide and were allowed to dry to immobilize microspheres on 2-dimensional surface of the glass slide.

After drying, the glass slide was imaged with an Olympus BH-2 microscope (Diagnostic Instruments, Inc. SPOT camera, CCD resolution of 1315×1033 pixels) to detect the color signals resulted from the development of couplers inside the microspheres.

1. A microarray comprising:
a support; on which is disposed;
a layer of microspheres bearing biological probes; wherein said microspheres comprise at least one material with a latent color that can be developed and used to identify said microsphere.

2. The microarray of claim 1 wherein the microspheres are arranged on the support in random or in orderly distribution.

3. The microarray of claim 1 wherein the latent colorant is capable of being developed to an optical signature.

4. The microarray of claim 3 wherein the optical signature is fluorescence, absorbence, or chemiluminescence.

5. The microarray of claim 3 wherein the latent colorant is capable of being developed to an optical signature by chemical or physical means.

6. The microarray of claim 5 wherein the chemical means is condensation reaction, acid-base reaction, redox reaction, abstraction reaction, addition reaction, elimination reaction, concerted reaction, chain propagated reaction, complexation reaction, molecular coupling reaction, rearrangement, or a combination of two or more of the foregoing.

7. The microarray of claim 5 wherein the physical means is a photo initiated process, a thermo initiated process, an ionizing radiation initiated process, an electron beam initiated process, an electrical initiated process, a pressure initiated process, a magnetic initiated process, an ultrasound initiated or a combination of two or more of the foregoing.

8. The microarray of claim 3 wherein the optical signature can be used to identify a target analyte.

9. The microarray of claim 1 wherein the material with a latent color is a leuco dye, a precursor of a leuco dye, a photographic coupler, a metal complexing ligand, a photochromic dye, or a thermochromic dye.

10. The microarray of claim 1 wherein the biological probe is bioactive.

11. The microarray of claim 10 wherein the bioactive probe comprises polynucleotide, polypeptide, polysaccharides, or small synthetic molecules.

12. The microarray of claim 1 wherein the microspheres are immobilized on a two dimensional support by chemical or physical interactions.

13. The microarray of claim 1 wherein the microspheres are immobilized on a two dimensional support by a gelation process.

14. The microarray of claim 1 wherein the microspheres have a mean diameter of 1 to 50 microns.

15. The microarray of claim 1 wherein the microspheres have a mean diameter of 5 to 20 microns.

16. The microarray of claim 1 wherein the concentration of microspheres on the support is 100 to a million per cm².

17. The microarray of claim 1 wherein the concentration of microspheres on the support is 10,000 to 100,000 per cm².

18. A method of identifying biological analytes, the method comprising the steps of:
providing an array of microspheres comprising latent colorants and biological probes;
making contact between said microspheres and said biological analytes, the analytes being labeled with optical emission tags;
allowing interaction between the biological analytes and the probes;
washing the array to remove unbound analytes;
recording signals from the optical emission tags, said signals generated from the binding of probe and analyte, and recording said signals as Image A;
developing the latent compounds in the microspheres into detectable optical signatures;
recording the optical signatures as Image B; and
comparing Images A and B to determine the identities and concentrations of the biological targets.

19. A method of identifying biological analytes, the method comprising the steps of:
providing microspheres that contain latent colorants and bear biological probes on their surfaces;
making contact between the microspheres and analytes, wherein the analytes are labeled with optical emission tags;
allowing interaction between the biological probes and the analytes;
washing microspheres to remove unbound analytes;
immobilizing said microspheres on a 2-dimensional surface of a support to form a microarray;
measuring signals from the optical emission tags, said signals generated from the interaction of probe and analyte, and recording the signals as Image A;
developing the latent colorants in the microspheres into detectable optical signatures and recording the signatures as Image B; and
comparing Images A and B to determine the identity and concentration of the analytes.
